(19) United States
(12) Patent Application Publication
(10) Pub. No.: US 2026/0145246 A1
(43) Pub. Date: May 28, 2026

(54) HIGH-HARDNESS WEAR-RESISTANT ANTIFRICTION COATING APPLIED TO HIGH-SPEED CUTTING TOOLS AND PREPARATION METHOD THEREOF

(71) Applicants: Taizhou University, Taizhou (CN); Wenling Research Institute of Taizhou University, Taizhou (CN); Taizhou Prade Coating Co., Ltd., Taizhou (CN)

(72) Inventors: Puyou YING, Taizhou (CN); Jun YIN, Taizhou (CN); Ping ZHANG, Taizhou (CN); Vladimir Levchenko, Taizhou (CN); Changhong LIN, Taizhou (CN); Tao YANG, Taizhou (CN); Jianbo WU, Taizhou (CN); Andrei Grigoriev, Taizhou (CN); Dmitri Gutsev, Taizhou (CN); Chengzhi MA, Taizhou (CN)

(73) Assignees: Taizhou University, Taizhou (CN); Wenling Research Institute of Taizhou University, Taizhou (CN); Taizhou Prade Coating Co., Ltd., Taizhou (CN)

(21) Appl. No.: 18/985,106

(22) Filed: Dec. 18, 2024

(30) Foreign Application Priority Data
Nov. 27, 2024 (CN) 202411719137.2

(51) Int. Cl. B23B 27/14; C23C 28/00

(52) U.S. Cl. CPC B23B 27/148; C23C 28/32; B23B 2222/88; B23B 2224/00; B23B 2228/105; B23B 2228/36

(57) ABSTRACT

A high-hardness wear-resistant antifriction coating applied to high-speed cutting tools and a preparation method thereof is provided. The coating includes an AlTiMoN upper layer and a Ti interlayer, the specific preparation steps are as follows: selecting Ti target power supply, performing titanium ion cleaning, depositing Ti interlayer, and then selecting Al₆₀Ti₃₀Mo₁₀ target, and depositing AlTiMoN layer. The prepared coating system has high hardness, good bonding force with the substrate, excellent wear-resistant and antifriction performance, and can effectively improve the cutting performance in the cutting process of the turning tools.

### CROSS-REFERENCE TO THE RELATED APPLICATIONS

This application is based upon and claims priority to Chinese Patent Application No. 202411719137.2, filed on Nov. 27, 2024, the entire contents of which are incorporated herein by reference.

### TECHNICAL FIELD

The present invention relates to the technical field of coating materials, in particular to a high-hardness wear-resistant antifriction coating applied to high-speed cutting tools and a preparation method thereof.

### BACKGROUND

Metal nitride coating has been widely used as a hard protective coating in the industry. Wherein TiN coating is the first generation metal nitride coating, which is typically used on various tool materials. However, the TiN coating is gradually replaced by other coatings due to the limited mechanical and tribological performance of the TiN coating.

In existing technology, an Al element is added to a TiN coating to form an AlTiN coating, the coating has a significant improvement in hardness, wear resistance, thermal stability and oxidation resistance, and the hardness of the coating can be increased to above 25 GPa. Additionally, since a dense Al₂O₃ layer is formed during the friction process, the wear resistance and oxidation resistance are significantly improved compared with TiN coating, and the friction coefficient is reduced. At high temperatures, the AlTiN coating maintains a stable single-phase cubic structure, which is suitable for high-speed cutting operations due to the coating has high thermal stability.

However, the friction coefficient of the coating is very high, higher than 0.7. In the cutting process, the high friction coefficient will lead to an increase in temperature of tools, accelerate the wear process of tools, and is not conducive to the service life of tools.

Therefore, in order to further improve the friction coefficient of the coating, the present invention proposes a high-hardness wear-resistant antifriction coating applied to high-speed cutting tools and a preparation method thereof.

### SUMMARY

An objective of the present invention is to provide a high-hardness wear-resistant antifriction coating applied to high-speed cutting tools and a preparation method thereof to solve problems in background technology.

In order to achieve the above objective, the present invention provides a high-hardness wear-resistant antifriction coating for high-speed cutting tools, including an AlTiMoN upper layer and a Ti interlayer, wherein in the AlTiMoN layer, a ratio of Al atoms is 20-25%, a ratio of Ti atoms is 10-15%, a ratio of Mo atoms is 4-6%, and a ratio of N atoms is 55-65%.

Preferably, the ratio of the Mo atoms is 10-15% of a total number of aluminum (Al) atoms, titanium (Ti) atoms and molybdenum (Mo) atoms.

The present invention also provides a preparation method for a high-hardness wear-resistant antifriction coating applied to high-speed cutting tools, including the following steps:
S1, Ti ion cleaning: placing a substrate on a sample holder, then placing the sample holder in a vacuum chamber, controlling a vacuum degree of a vacuum chamber to be 7×10⁻³-9×10⁻³ Pa after raising the temperature, introducing Ar, and after adjusting air pressure, turning on a Ti target power supply to perform Ti ion cleaning;
S2, deposition of Ti interlayer: after the Ti ion cleaning is completed, reducing a bias voltage of the Ti target power supply, and depositing the Ti layer;
S3, deposition of the AlTiMoN layer: after the deposition of the Ti layer is completed, selecting an Al₆₀Ti₃₀Mo₁₀ target, simultaneously introducing N₂ and Ar, turning on the AlTiMo target power supply after adjusting the air pressure, and obtaining a high-hardness wear-resistant antifriction coating after the deposition is completed.

Preferably, in S1, the vacuum chamber is heated to 350-400° C., the air pressure is 0.2-0.5 Pa, the bias voltage of the Ti target power supply is −800V-−1000V, and the cleaning time of Ti ions is 3-5 min.

Preferably, in S1, the vacuum chamber is heated to 350° C., the bias voltage of the Ti target power supply is −1000V, and the cleaning time of the Ti ions is 3 min.

Preferably, in S2, the bias voltage is −300V-−400V, the target current is controlled at 60-80 A, the deposition time is 25-35 min, and the deposition thickness of the Ti layer is 200-400 nm.

Preferably, in S2, the bias voltage is −300V, the target current is controlled at 80 A, the deposition time is 25 min.

Preferably, in S3, a gas flow ratio of N₂ to Ar is 8:1-10:1, and the air pressure is adjusted to 0.5-3.0 Pa.

Preferably, in S3, the bias voltage is −100V-−200V, the target current is 60-80 A, the deposition time is 120-180 min, and the thickness of the AlTiMoN layer is 2.0-3.0 μm.

Preferably, in S3, the bias voltage is −100V, the target current is 80 A, the deposition time is 120 min.

Preferably, the high-hardness wear-resistant antifriction coating prepared by the above preparation method has a hardness greater than 30 GPa and a coating-substrate bonding force than 65 N; a wear rate is less than 3×10⁻⁶ mm³/(N·m) and a friction coefficient is less than 0.5.

Preferably, the prepared high-hardness wear-resistant antifriction coating is applied to the field of surface protection coating of high-speed cutting tools.

Therefore, the present invention relates to a high-hardness wear-resistant antifriction coating applied to high-speed cutting tools and a preparation method thereof, which has the following beneficial effects:
(1) in the present invention, the AlTiMoN coating is used, the doped Mo atom will replace part of the Ti atom in the (Al, Ti) N phase of the AlTiN coating, leading to a solid solution strengthening effect, which helps to improve the hardness of the coating.
(2) The addition of the Mo element can also improve the hardness of the coating by forming a harder Mo₂N phase, during the friction wear and cutting process, the Mo₂N phase forms oxide MoO₃, which belongs to the Magnéli phase, and has a self-lubricating effect in friction, it can effectively reduce the friction coefficient of the coating, thereby reducing wear and finally improving the tribological behaviours, wear resistance and cutting performance of the coating.
(3) The multi-metal nitride coating system prepared according to the present invention has high hardness, good bonding force with the substrate, excellent wear-resistant and antifriction performance, and the coating has the advantages of low wear rate and low friction coefficient, which can be well applied to high-speed cutting tools and other fields.

Further detailed descriptions of the technical scheme of the present invention can be found in the accompanying drawings and embodiments.

### BRIEF DESCRIPTION OF THE DRAWINGS

FIGS. 1A and 1B show a scanning electron microscope (SEM) morphology of embodiment 1 of the present invention, wherein FIG. 1A is a surface morphology and FIG. 1B is a cross-sectional morphology;

FIG. 2 is an X-ray diffraction (XRD) pattern of embodiment 1 of the present invention;

FIGS. 3A-3C show a scratch comparison diagram of embodiment 1, comparative embodiment 1, and comparative embodiment 2 of the present invention, wherein FIG. 3A is embodiment 1, FIG. 3B is comparative embodiment 1, and FIG. 3C is comparative embodiment 2;

FIGS. 4A and 4B show a cutting performance comparison diagram of embodiment 1 and comparative embodiment 1 of the present invention, wherein FIG. 4A is embodiment 1 and FIG. 4B is comparative embodiment 1;

FIGS. 5A and 5B show a friction coefficient curve and wear rate comparison diagram of embodiment 1, comparative embodiment 1 and comparative embodiment 2, wherein FIG. 5A is a friction coefficient curve and FIG. 5B is a wear rate.

### DETAILED DESCRIPTION OF THE EMBODIMENTS

The technical solution of the present invention will be further elaborated hereafter in conjunction with accompanying drawings and embodiments.

In order to make the objectives, the technical solutions, and the advantages of the present invention clearer, the following clearly and completely describes the technical solutions in embodiments of the present invention with reference to the drawings of embodiments of the present invention. Apparently, the described embodiments are only some but not all of the embodiments of the present invention.

### Embodiment 1

This embodiment provides a high-hardness wear-resistant antifriction coating, which includes an AlTiMoN layer and a Ti interlayer from top to bottom, the atomic percentage content of each element in the coating is: the ratio of Al atom is 20.8%, the ratio of Ti atom is 12.5%, the ratio of Mo atom is 5.1%, the ratio of N atom is 61.6%, where Mo/(Al+Ti+Mo)=13.3%.

The preparation methods are as follows:
S1, the cemented carbide YG8 was selected as the substrate, and the substrate was placed in acetone and alcohol for ultrasonic cleaning, after cleaning and drying, it was mounted on the sample holder;
the sample holder was put into the vacuum chamber, the chamber door was closed to start vacuuming, and the temperature was started to rise to 350° C. at the same time; when the air pressure of the vacuum chamber was pumped below 9×10⁻³ Pa, Ar gas was introduced, the pressure was maintained at 0.5 Pa, the Ti target power supply was turned on, the bias voltage was selected to be −1000V, and the cleaning time was 3 min;
S2, deposition of the Ti interlayer: the bias voltage of the Ti target power supply was selected to be −300V, the current was selected to be 80 A, and the deposition time was 25 min; the thickness of the Ti interlayer of about 320 nm was obtained after deposition.

S3, deposition of AlTiMoN layer: nitrogen and argon were introduced simultaneously, and the flow ratio was controlled at 8:1; the air pressure was controlled at about 0.5 Pa, only the Al₆₀Ti₃₀Mo₁₀ target power supply was turned on, the bias voltage was selected to be −100V, the current was selected to be 80 A, and the deposition time was 120 min; the thickness of the AlTiMoN layer of about 2.4 μm was obtained after deposition.

After the coating was completed, the power supply and gas were turned off, and the sample holder was taken out when the temperature was reduced to about 50° C.

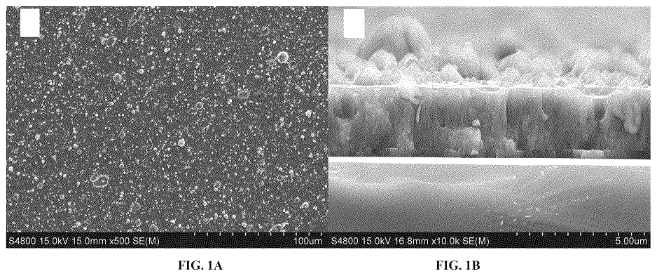

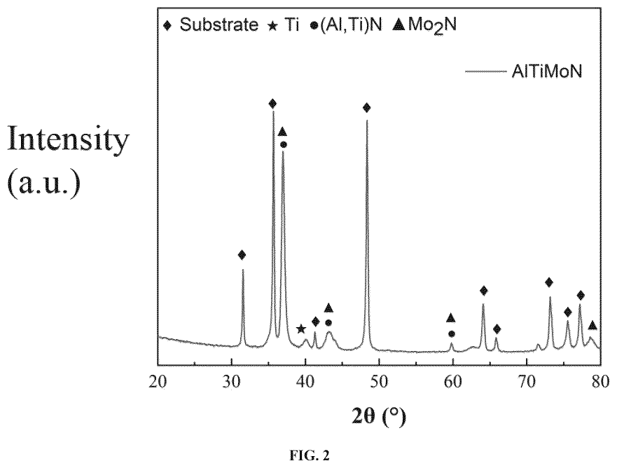

The morphology and performance of the above coatings were tested, where the surface morphology and cross-sectional morphology are shown in FIGS. 1A and 1B, the performance of the coatings was as follows: hardness was 32.1 GPa; the bonding force between the coating and the substrate was 68 N; the wear rate was 1.9×10⁻⁶ mm³/(N·m); the friction coefficient was about 0.45. The above coatings were tested by XRD, as shown in FIG. 2, after analysis, it was found that in addition to the (Al, Ti) N phase, the Mo₂N phase was also formed in the prepared AlTiMoN coating; the diffraction peak position of the (Al, Ti) N phase shifted to a certain extent, it was indicated that Mo atoms replaced some Ti atoms in the (Al, Ti) N phase; the formation of Mo₂N phase with higher hardness in the coating and the solid solution strengthening caused by Mo atom replacement contribute to the improvement of the hardness of the AlTiMoN coating. In addition, the Mo₂N phase will generate the MoO₃ phase with a self-lubricating effect during the friction and wear and cutting process, which can effectively reduce the friction coefficient of the coating, thereby reducing wear to improve the tribological behaviours, wear resistance and cutting performance of the coating.

### Embodiment 2

This embodiment provides a high-hardness wear-resistant antifriction coating, which includes an AlTiMoN layer and a Ti layer from top to bottom, the atomic percentage content of each element in the coating is: the ratio of Al atom is 23.6%, the ratio of Ti atom is 10.8%, the ratio of Mo atom is 4.2%, the ratio of N atom is 61.4%, where Mo/(Al+Ti+Mo)=10.9%.

Its preparation methods are as follows:
S1, the cemented carbide YG8 was selected as the substrate, and the substrate was placed in acetone and alcohol for ultrasonic cleaning, after cleaning and drying, it was mounted on the sample holder;
the sample holder was put into the vacuum chamber, the chamber door was closed to start vacuuming, and the temperature was started to rise to 400° C. at the same time; when the air pressure of the vacuum chamber was pumped below 9×10⁻³ Pa, Ar gas was introduced, the pressure was maintained at 0.5 Pa, the Ti target power supply was turned on, the bias voltage was selected to be −800V, and the cleaning time was 5 min;
S2, deposition of the Ti interlayer: the bias voltage of the Ti target power supply was selected to be −300V, the current was selected to be 80 A, and the deposition time was 35 min; the thickness of the Ti interlayer of about 360 nm was obtained after deposition.
S3, deposition of AlTiMoN layer: nitrogen and argon were introduced simultaneously, and the flow ratio was controlled at 10:1; the air pressure was controlled at about 3.0 Pa, only the Al₆₀Ti₃₀Mo₁₀ target power supply was turned on, the bias voltage was selected to be −200V, the current was selected to be 80 A, and the deposition time was 180 min; the thickness of the AlTiMoN layer of about 2.8 μm was obtained after deposition.

After the coating was completed, the power supply and gas were turned off, and the sample holder was taken out when the temperature was reduced to about 50° C.

The performance of the above coatings was tested, the performance of the coatings was as follows: hardness was 30.1 GPa; the bonding force between the coating and the substrate was 66 N; the wear rate was 2.5×10⁻⁶ mm³/(N·m); the friction coefficient was about 0.48.

### Comparative Embodiment 1

This comparative embodiment provides an AlTiN coating system, which includes an AlTiN layer and a Ti interlayer from top to bottom, the atomic percentage content of each element in the coating is: the ratio of Al atom is 27.2%, the ratio of Ti atom is 15.8%, the ratio of N atom is 57.0%.

The preparation methods are as follows:
S1, the cemented carbide YG8 was selected as the substrate, and the substrate was placed in acetone and alcohol for ultrasonic cleaning, after cleaning and drying, it was mounted on the sample holder;
the sample holder was put into the vacuum chamber, the chamber door was closed to start vacuuming, and the temperature was started to rise to 350° C. at the same time; when the air pressure of the vacuum chamber was pumped below 9×10⁻³ Pa, Ar gas was introduced, the pressure was maintained at 0.5 Pa, the Ti target power supply was turned on, the bias voltage was selected to be −1000V, and the cleaning time was 3 min;
S2, deposition of the Ti interlayer: the bias voltage of the Ti target power supply was selected to be −300V, the current was selected to be 80 A, and the deposition time was 25 min; the thickness of the Ti interlayer of about 210 nm was obtained after deposition.
S3, deposition of AlTiN layer: nitrogen and argon were introduced simultaneously, and the flow ratio was controlled at 5:1; the air pressure was controlled at about 0.5 Pa, only the Al₆₇Ti₃₃ target power supply was turned on, the bias voltage was selected to be −100V, the current was selected to be 80 A, and the deposition time was 120 min; the thickness of the AlTiN layer of about 3.3 μm was obtained after deposition.

After the coating was completed, the power supply and gas were turned off, and the sample holder was taken out when the temperature was reduced to about 50° C.

The performance of the above coatings was tested, the performance of the coatings was as follows: hardness was 27.2 GPa; the wear rate was 5.4×10⁻⁶ mm³/(N·m); the friction coefficient was about 0.80.

### Comparative Embodiment 2

This comparative embodiment provides an AlTiMoN coating system, which includes an AlTiMoN layer and a Ti interlayer from top to bottom, the atomic percentage content of each element in the coating is: the ratio of Al atom is 20.4%, the ratio of Ti atom is 10.3%, the ratio of Mo atom is 3.3%, the ratio of N atom is 66.0%, where Mo/(Al+Ti+Mo)=9.7%.

The preparation methods are as follows:
(1), the cemented carbide YG8 was selected as the substrate, and the substrate was placed in acetone and alcohol for ultrasonic cleaning, after cleaning and drying, it was mounted on the sample holder;
the sample holder was put into the vacuum chamber, the chamber door was closed to start vacuuming, and the temperature was started to rise to 200° C. at the same time; when the air pressure of the vacuum chamber was pumped below 9×10⁻³ Pa, Ar gas was introduced, the pressure was maintained at 0.5 Pa, the Ti target power supply was turned on, the bias voltage was selected to be −800V, and the cleaning time was 5 min;
(2), deposition of the Ti interlayer: the bias voltage of the Ti target power supply was selected to be −400V, the current was selected to be 60 A, and the deposition time was 30 min; the thickness of the Ti interlayer of about 300 nm was obtained after deposition.
(3), deposition of AlTiMoN layer: nitrogen and argon were introduced simultaneously, and the flow ratio was controlled at 5:1; the air pressure was controlled at about 2.0 Pa, only the Al₆₀Ti₃₀Mo₁₀ target power supply was turned on, the bias voltage was selected to be −100V, the current was selected to be 60 A, and the deposition time was 120 min; the thickness of the AlTiMoN layer of about 2.0 μm was obtained after deposition.

After the coating was completed, the power supply and gas were turned off, and the sample holder was taken out when the temperature was reduced to about 50° C.

The performance of the above coatings was tested, the performance of the coatings was as follows: hardness was 27.5 GPa; the bonding force between the coating and the substrate was 66 N; the wear rate was 3.8×10⁻⁶ mm³/(N·m); the friction coefficient was about 0.55.

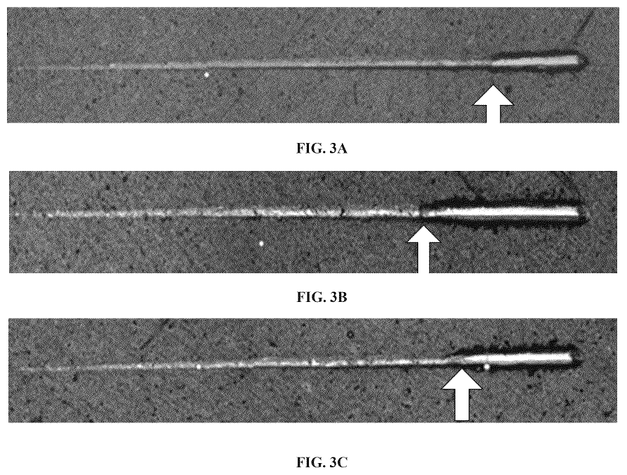

The scratch test, cutting performance test and friction test were carried out on the coating in embodiment 1, the coating in comparative embodiment 1 and the coating in comparative embodiment 2, respectively, wherein the scratch comparison diagram is shown in FIGS. 3A-3C, through analysis and calculation, the bonding force between the AlTiMoN coating and the substrate in embodiment 1 is 68 N, while the bonding force between the AlTiMoN coating and the substrate in comparative embodiment 1 is 63 N, and the bonding force between the AlTiMoN coating and the substrate in comparative embodiment 2 is 66N, it was indicated that the bonding force between the AlTiMoN coating and the substrate is better, and the bonding force between the AlTiMoN coating and the substrate of embodiment 1 is better than the bonding force between the AlTiMoN coating and the substrate of comparative embodiment 2.

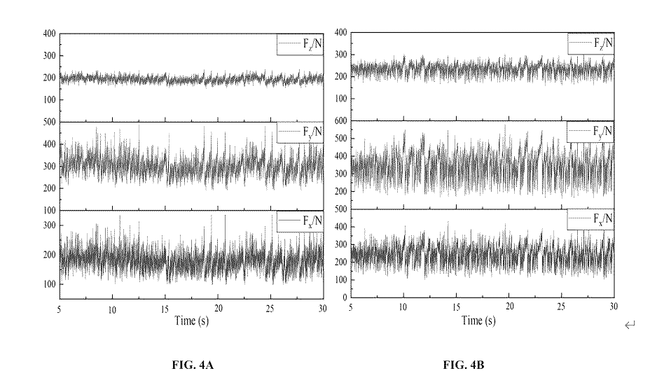

The cutting performance comparison diagram of embodiment 1 and comparative embodiment 1 is shown in FIGS. 4A and 4B, it can be seen that the cutting force and cutting temperature of the tools coated with AlTiMoN coating are significantly lower than the cutting force and cutting temperature of the tools coated with AlTiN coating during the cutting process, it was indicated that the cutting performance of the AlTiMoN coating is better than the cutting performance of AlTiN.

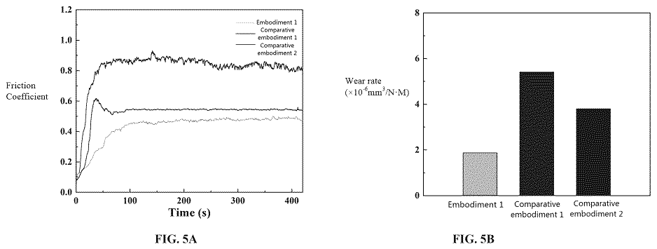

The friction coefficient curve and wear rate comparison diagram of embodiment 1, comparative embodiment 1 and comparative embodiment 2 are shown in FIGS. 5A and 5B, the results showed that the friction coefficient and wear rate of AlTiMoN coating are significantly lower than the friction coefficient and wear rate of AlTiN coating, that is, the tribological behaviours and wear resistance of AlTiMoN coating are better than tribological behaviours and wear resistance of AlTiN coating; in addition, the tribological behaviours and wear resistance of the AlTiMoN coating in embodiment 1 are better than tribological behaviours and wear resistance of the AlTiMoN coating in comparative embodiment 2.

In conclusion, after adding the Mo element to the AlTiN coating in comparative embodiment 1, the comprehensive performance of the AlTiMoN coating is obviously better than the comprehensive performance of the AlTiN coating due to the addition of the Mo element. In addition, the comprehensive performance of AlTiMoN coating in embodiment 1 is better than the comprehensive performance of AlTiMoN coating in comparative embodiment 2, and the process parameters in comparative embodiment 2 are not optimized, especially the ratio of gas in the preparation process. The ratio of gas of nitrogen to argon will affect the composition of the prepared AlTiMoN coating, in this present invention, the gas flow ratio of N₂ to Ar is limited to 8:1-10:1, the coating with better performance can be obtained in this range; secondly, the Mo content in the AlTiMoN coating will significantly affect the comprehensive performance of the coating, in this present invention, the ratio of Mo atoms is limited to 4-6%, and the ratio of Mo atoms is 10-15% of the total number of aluminum, titanium and molybdenum atoms by adjusting the process parameters of the deposition process, which can significantly improve the comprehensive performance of the AlTiMoN coating.

Therefore, the present invention provides a high-hardness wear-resistant antifriction coating applied to high-speed cutting tools and preparation method thereof, where the prepared coating system has high hardness, good bonding force with the substrate, excellent wear-resistant and antifriction performance, and can effectively improve the cutting performance in the cutting process of the turning tools.

Finally, it should be noted that the above examples are merely used for describing the technical solutions of the present invention, rather than limiting the same. Although the present invention has been described in detail with reference to the preferred examples, those of ordinary skill in the art should understand that the technical solutions of the present invention may still be modified or equivalently replaced. However, these modifications or substitutions should not make the modified technical solutions deviate from the spirit and scope of the technical solutions of the present invention.

What is claimed is:

1. A high-hardness wear-resistant antifriction coating for high-speed cutting tools, wherein
comprising an AlTiMoN upper layer and a Ti interlayer, wherein in the AlTiMoN upper layer, a ratio of Al atoms is 20-25%, a ratio of Ti atoms is 10-15%, a ratio of Mo atoms is 4-6%, and a ratio of N atoms is 55-65%.

2. The high-hardness wear-resistant antifriction coating for the high-speed cutting tools according to claim 1, wherein the ratio of the Mo atoms is 10-15% of a total number of the Al atoms, the Ti atoms and the Mo atoms.

3. A preparation method for the high-hardness wear-resistant antifriction coating according to claim 1, wherein comprising the following steps:
S1, Ti ion cleaning: placing a substrate on a sample holder, placing the sample holder in a vacuum chamber, controlling a vacuum degree of the vacuum chamber to be 7×10⁻³-9×10⁻³ Pa after raising temperature, introducing Ar, and after adjusting air pressure, turning on a Ti target power supply to perform the Ti ion cleaning;
S2, deposition of the Ti interlayer: after the Ti ion cleaning is completed, reducing a bias voltage of the Ti target power supply, and depositing the Ti interlayer;
S3, deposition of the AlTiMoN upper layer: after the deposition of the Ti interlayer is completed, selecting an Al₆₀Ti₃₀Mo₁₀ target, simultaneously introducing N₂ and Ar, turning on a AlTiMo target power supply after adjusting the air pressure, and obtaining the high-hardness wear-resistant antifriction coating after the deposition of the AlTiMoN upper layer is completed.

4. The preparation method according to claim 3, wherein in S1, the vacuum chamber is heated to 350-400° C., the air pressure is 0.2-0.5 Pa, the bias voltage of the Ti target power supply is −800V-−1000V, and a cleaning time of Ti ions is 3-5 min.

5. The preparation method according to claim 3, wherein in S1, the vacuum chamber is heated to 350° C., the bias voltage of the Ti target power supply is −1000V, and a cleaning time of Ti ions is 3 min.

6. The preparation method according to claim 3, wherein in S2, the bias voltage is 300V-−400V, a target current is controlled at 60-80 A, a deposition time is 25-35 min, and a deposition thickness of the Ti interlayer is 200-400 nm.

7. The preparation method according to claim 3, wherein in S2, the bias voltage is −300V, a target current is controlled at 80 A, a deposition time is 25 min.

8. The preparation method according to claim 3, wherein in S3, a gas flow ratio of N₂ to Ar is 8:1-10:1, and the air pressure is adjusted to 0.5-3.0 Pa.

9. The preparation method according to claim 3, wherein in S3, the bias voltage is 100V-−200V, a target current is 60-80 A, a deposition time is 120-180 min, and a thickness of the AlTiMoN upper layer is 2.0-3.0 μm.

10. The preparation method according to claim 3, wherein in S3, the bias voltage is −100V, a target current is 80 A, a deposition time is 120 min.

11. The preparation method according to claim 3, wherein in the high-hardness wear-resistant antifriction coating, the ratio of the Mo atoms is 10-15% of a total number of the Al atoms, the Ti atoms and the Mo atoms.

12. The preparation method according to claim 11, wherein in S1, the vacuum chamber is heated to 350-400° C., the air pressure is 0.2-0.5 Pa, the bias voltage of the Ti target power supply is −800V-−1000V, and a cleaning time of Ti ions is 3-5 min.

13. The preparation method according to claim 11, wherein in S1, the vacuum chamber is heated to 350° C., the bias voltage of the Ti target power supply is −1000V, and a cleaning time of Ti ions is 3 min.

14. The preparation method according to claim 11, wherein in S2, the bias voltage is 300V-−400V, a target current is controlled at 60-80 A, a deposition time is 25-35 min, and a deposition thickness of the Ti interlayer is 200-400 nm.

15. The preparation method according to claim 11, wherein in S2, the bias voltage is −300V, a target current is controlled at 80 A, a deposition time is 25 min.

16. The preparation method according to claim 11, wherein in S3, a gas flow ratio of N₂ to Ar is 8:1-10:1, and the air pressure is adjusted to 0.5-3.0 Pa.

17. The preparation method according to claim 11, wherein in S3, the bias voltage is 100V-−200V, a target current is 60-80 A, a deposition time is 120-180 min, and a thickness of the AlTiMoN upper layer is 2.0-3.0 μm.

18. The preparation method according to claim 11, wherein in S3, the bias voltage is −100V, a target current is 80 A, a deposition time is 120 min.
